(19) United States
(12) Patent Application Publication
(10) Pub. No.: US 2006/0174667 A1
(43) Pub. Date: Aug. 10, 2006

(54) Security device and system for use therewith

(76) Inventor: Glen Walter Garner, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/051,484

(22) Filed: Feb. 7, 2005

(51) Int. Cl. E05B 65/00

(52) U.S. Cl. 70/57.1

(57) ABSTRACT

A security device includes at least two pins and at least two locks. Each lock is adapted to releasably receive one pin. At least one of the at least two pins and the at least two locks are attached together. The device has a release position wherein the pins are not in the locks and a locked position where the pins are secured in the locks. In another aspect of the invention there is provided a detacher for use with two locks.

### FIELD OF THE INVENTION

This invention relates to security devices and in particular security devices that use at least two locks.

### BACKGROUND OF THE INVENTION

The use of security devices in retail establishments has become wide spread over the last decades. During the last forty years there have been three main methods to secure a tag on a garment with a pin. One major company Sensormatic, now owned by Tyco introduced the Tinnerman™ lock in the 70s, and then followed with a later locking mechanism for their Supertag™. Both these designs have proven to be very successful for the retailers mainly for Apparel fashion goods. The third major lock in this field of security is a ball lock, there are many variations in design however the general concept is that a magnet is used to pull the spring and the attached plunger to reduce pressure on the ball bearings thereby releasing the pin. The ball lock type lock has been applied to other products such as video cases and DVD cases for the security of media and software.

There are a number of difficulties associated with these types of security systems. Specifically, 99% of all security devices used in the market can be released with three different styles of detachers. Therefore a typical shopping mall in the USA may have a wide variety of security devices but they can be simply removed with one of three detachers and most probably just one. Accordingly, for someone intent on stealing the use of one universal detacher makes the theft considerably easier. Another limitation is that for the most part these security devices and pins are for the protection of clothing. Other items in a typical department store environment cannot be protected in the same manner.

Accordingly it would be advantageous to provide a security device that cannot be readily removed with one of the three detachers. Further it would be advantageous to provide a security system that can be readily adapted so that each retailer can have a unique configuration requiring a specific detacher. Further it would be advantageous to provide security devices that can be easily used on items other than clothing.

### SUMMARY OF THE INVENTION

The present invention is a security device which includes at least two pins and at least two locks. Each lock is adapted to releasably receive one pin. At least one of the at least two pins and the at least two locks are attached together. The device has a release position wherein the pins are not in the locks and a locked position where the pins are secured in the locks.

In another aspect of the invention there is provided a detacher assembly for use in association with security devices having at least two locks and a corresponding number of pins. The detacher assembly includes a plurality of detachers corresponding to the number of locks associated with the security device.

In a further aspect of the invention there is provided a security device adapted to be attached to a product including as least two spaced apart pins, at least two spaced apart locks and a bridging member. The at least two spaced apart pins are attached together to form a male portion. The at least two spaced apart locks are attached together to form a female portion and each lock is adapted to releasably receive one pin. The bridging member connects the male portion and the female portion. The device has a release position wherein the pins are not in the locks and a locked position where the pins are secured in the locks and in the locked position the bridging member is wrapped around a portion of the product.

In a still further aspect of the invention there is provided a security device adapted to be attached to a product including at least one pin on a male portion, at least one lock on a female portion. Each lock Is adapted to releasably receive one pin. The security device is manufactured from non-metallic material.

In a still further aspect of the invention there is provided a security device for use in association with digital storage medium such as CD's, DVD's and the like. The security device includes a jewel case adapted to receive the digital storage medium having a front portion and a back portion; at least two locks connected to the jewel case; and at least two pins each releasably connectable to the one of the locks.

In another aspect of the invention there is provided a security device including a blister package having at least one lock; and at least one pin adapted to be releasably connected to the lock.

In a further aspect of the invention there is provided a security device for use in association with small products such as ties, socks, belts and the like. The security device includes a hanger portion; a lock connected to the hanger portion; and a pin connected to the hanger portion. The security devise has a release position wherein the pin is not in the lock and a locked position wherein the pin is secured in the lock through at least a portion of the small product.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a two pin security device constructed in accordance with the present invention;

FIG. 2 is a top view of a two pin security device constructed in accordance with the present invention and shown in conjunction with a compact disc;

FIG. 3 is a cross sectional view of an asymmetric lock showing a left wedge;

FIG. 4 is a cross sectional view of an asymmetric lock showing a right wedge;

FIG. 5 is a cross sectional view of a detacher constructed in accordance with the present invention for use in association with a security device having two asymmetric locks therein;

FIG. 6 is a cross sectional view of an alternate detacher constructed in accordance with the present invention for use in association with a security device having two asymmetric locks therein;

FIG. 7 is a top view of an adjustable detacher constructed in accordance with the present invention for use in association with a security tag having two locks therein;

FIG. 8 is a cross sectional view of a ball lock;

FIG. 9 is a front view of a security device of the present invention for use in association with spectacles and the like shown on the arm of a spectacle;

FIG. 10 is a front view of the security device of FIG. 9 but in the open position;

FIG. 11 is a front view of a security device similar to that shown in FIG. 9 but adapted to be attached to electrical chords and the like;

FIG. 12 is a front view of a security device similar to that shown in FIG. 9 but adapted to be used on products such as wine bottles and the like;

FIG. 13 is a front view of the security device of FIG. 12 but in the open position;

FIG. 14 is a front view of a security device constructed in accordance with the present invention which includes a hanger for products such as ties, belts, scarves and the like;

FIG. 15 is a front view of a security device similar to that shown in FIG. 14;

FIG. 16 is a front view of a security device including a hanger for use in association with products such as socks;

FIG. 17 is a top view of a security device for use in association with products having a generally round portion;

FIG. 18 is a top view of a security device having a generally curved female portion;

FIG. 19 is a front view of a security device for use with CD's, DVD's and the like;

FIG. 20 is a cross sectional front view of the security device shown in FIG. 1 and showing a sensor and ink vials;

FIG. 21 is a cross sectional front view of the security device shown in FIG. 1 and showing ink vials;

FIG. 22 is a cross sectional front view of the security device shown in FIG. 1 and showing an RF coil;

FIG. 23 is a cross sectional front view of the security device shown in FIG. 1 and showing an AM sensor;

FIG. 24 is a cross sectional front view of the security device shown in FIG. 1 and showing RF coil and ink vials;

FIG. 25 is a cross sectional front view of the security device shown in FIG. 1 and showing an electromagnetic sensor;

FIG. 26 is a cross sectional front view of the security device shown in FIG. 1 and showing an RF coil and an AM sensor;

FIG. 27 is a cross sectional front view of the security device shown in FIG. 1 and showing RF coil, AM sensor and an electromagnetic sensor;

FIG. 28 is a front view of a security device of the present invention as part of blister type package;

FIG. 29 is a top view of a detacher for use with multiple configurations of security devices;

FIG. 30 is a perspective view of a deactivation device for use in association with the security devices of the present invention;

FIG. 31 is a side view of a security device constructed in accordance with the present invention having a single lock;

FIG. 32 is a top view of the security device of FIG. 31;

FIG. 33 is a bottom view of the security device of FIG. 31;

FIG. 34 is a side view of a security device constructed in accordance with the present invention showing an alternate shaped asymmetric lock over a prior art detacher; and

FIG. 35 is a side view of a security device constructed in accordance with the present invention showing an elongate shaped asymmetric lock over a prior art detacher.

### DETAILED DESCRIPTION OF THE INVENTION

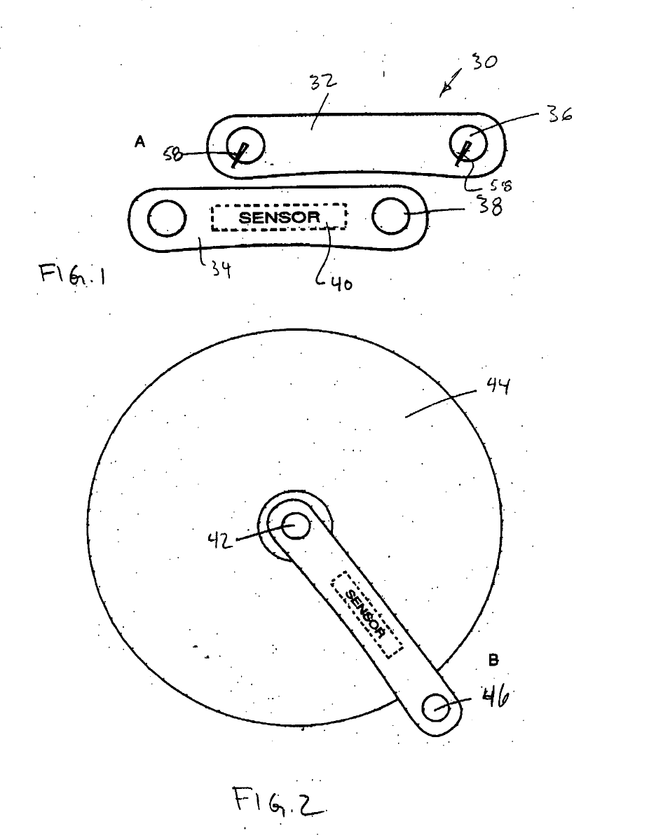

Referring to FIG. 1, the security device of the present invention is shown generally at 30. Security device 30 includes the male portion 32 and the female portion 34. The male portion 32 includes pins 36 and the female portion 34 includes the pin receiving portions 38. Preferably at least two pins 36 and pin receiving portions 38 will be used with the tags 30 of the present invention. Typically the security device 30 will also include a sensor 40. Sensor 40 may be attached to the male portion 32 or the female portion 34.

The distance between the pins 36 can vary depending on the intended use. As shown in FIG. 2 the distance between the pins 36 can be arranged such that a first pin 42 can be positioned in the centre of a compact disc or DVD 44 and a second pin 46 may be positioned on the outside of the disc. A wide variety of configurations may be used and some further variations will be discussed below.

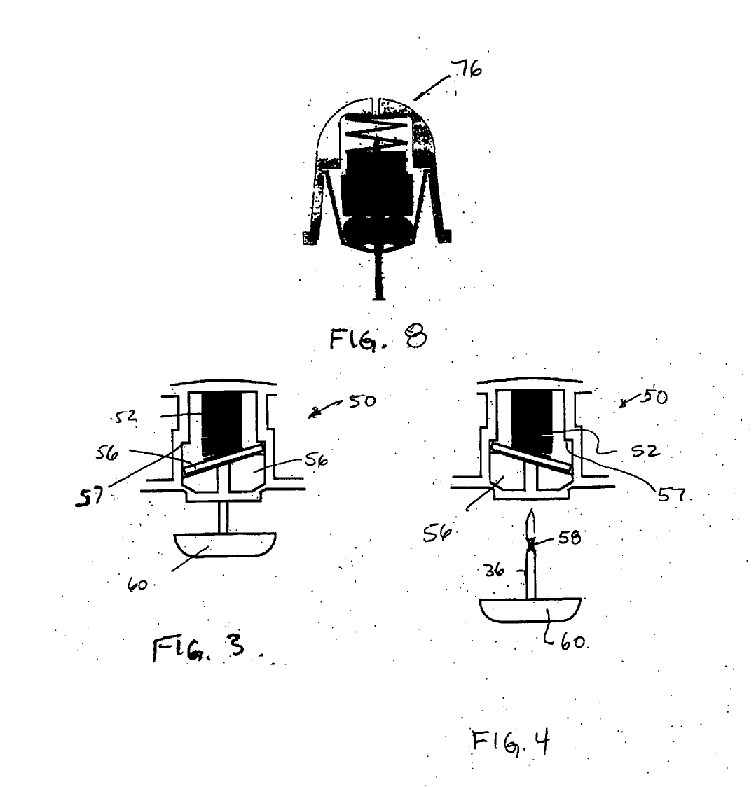

Preferably, the pin receiving portion 38 used in conjunction with the security device 30 of the present invention will be an asymmetric magnetic lock 50 as shown in FIGS. 3 and 4. The lock 50 is made up of a spring 52, washer 54 with a pierced hole and an asymmetric wedge 56 with a hole. In the engaged position the pin 36 is inserted through the hole in the asymmetric wedge 56 and the pierced hole in the washer 54. Each pin 36 has a groove 58 therein. The washer 54 engages the groove 58 and holds the pin 36 in place. The angle of the wedge is arranged such that it is sufficient to hold the pin 36 in place. When the magnet is placed at the correct side of asymmetric wedge 56 either left or right depending on the orientation of the wedge, the magnetic pull pulls the washer horizontal thereby releasing the pin. Preferably the washer is disc shaped however other shapes could also be used. Preferably the lock is provided with a wedge seat 57 such that when the washer is pulled back it will rest against the wedge seat 57. It will be appreciated by those skilled in the art that the spring can be made in different configurations and strength. The spring 52 biases the washer 54 into the correct position against the asymmetric wedge 56. Further it will be appreciated by those skilled in the art that the release of the pin 36 will work most effectively if the magnet is placed correctly in regard to the wedge 56, however, it may be possible for a magnet in other positions to effectively release the pin 36.

The pin 36 may be part of a male portion 32 as shown in FIG. 1 or individual pins as shown in FIGS. 3 and 4. An individual pin includes a head 60 and a pin 36 with a groove 58 formed therein. The pins 36 can vary in length and style.

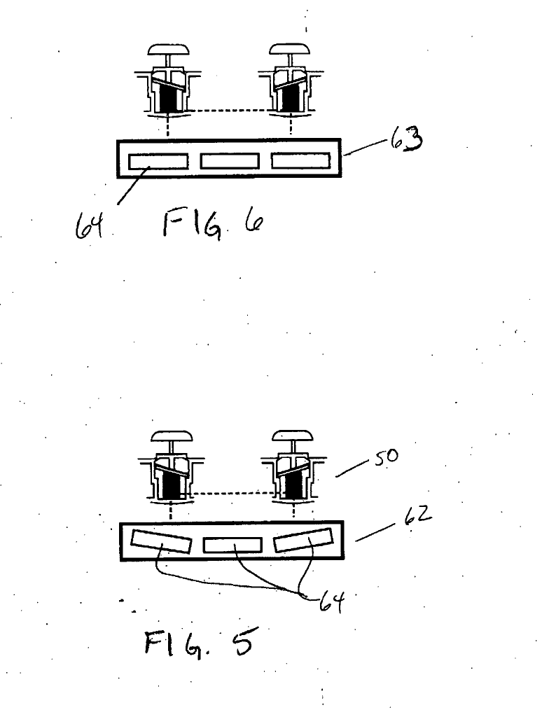

One advantage of the asymmetric locks 50 shown in FIGS. 3 and 4 is that the magnets used to move the washer and thus release the pin are most effective if placed in the appropriate position relative to the wedge 56 in order for the pin to be successfully released. For example, lock 50 shown in FIG. 3 having the high portion of the wedge 56 on the right works best if a magnet to be positioned on the left of the lock and not beneath. Conversely lock 50 shown in FIG. 4 works best if the magnet is positioned left of the lock. Accordingly for a two lock tag as that shown in FIGS. 1 and 2 a detacher 62 as shown in FIG. 5 could be used. This detacher 62 has three magnets 64. The outer magnets 64 are angled to release the washers in asymmetric holder. The middle magnet 64 is to deactivate the senor. It will be appreciated by those skilled in the art that the middle magnet will only be present for certain applications. In detacher 62 the magnets are angled to further increase their efficiency. It has been found that relatively weak magnets work effectively in this application. Alternatively the magnets may be placed in the same plane as shown in detacher 63 in FIG. 6.

It will be appreciated by those skilled in the art that the two pin tag shown in FIGS. 1 and 2 can be easily adapted by changing the orientation of the asymmetric lock thus requiring a different detacher. For example with a wide variety of configurations can easily be assembled. Essentially the locks can be positioned in a 360° orientation. Some example orientations are (I) left lock and left lock, (ii) right lock and right lock (iii) left lock and right lock (iv) right lock and left lock. However it will be clear to those skilled in the art that these are merely examples and a much wider variety of orientations could be used. Clearly if the tag is adapted to include three or more locks this further adds to the variations that are available to retailers. As a further variation the distance between the pin receiving portions or locks 38 can vary and a specific distance could be reserved for a specific customer. The asymmetric lock also has the advantage that it weighs less than a conventional lock. Further, the lock may be used with a shorter pin thus head can be produced with less depth using a shorter pin.

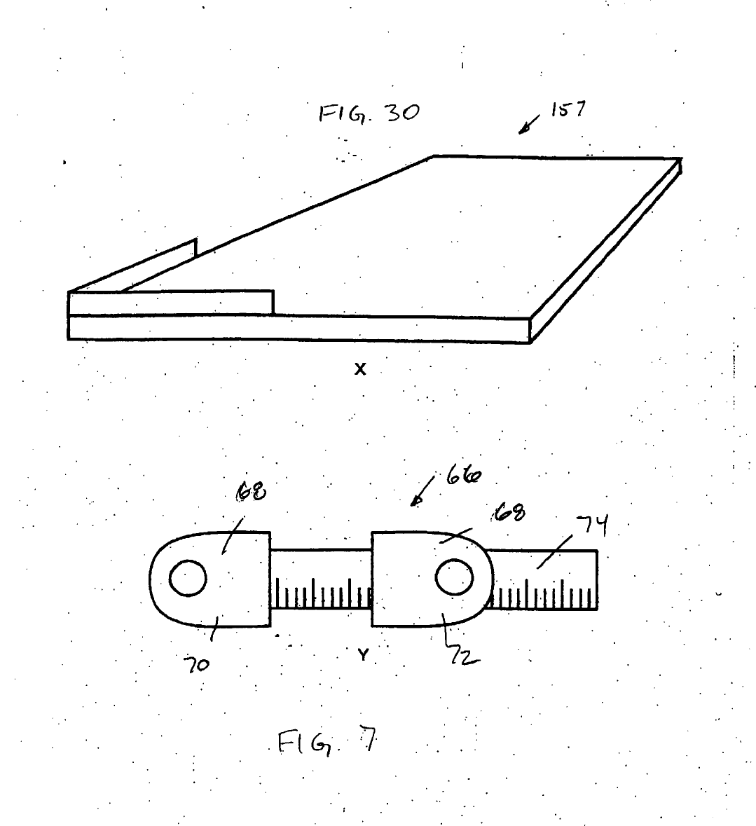

The security device of the present invention provides retailers with a variety of alternatives. For example, one retailer may require a two lock system but wherein the distance between the locks varies within a specific retail establishment. As another example the distance between locks 38 may be small where the tag is used on clothes and the distance may be larger when the tag is used on a DVD or CD. However, the orientation of the locks could be the same. Thus an adjustable detacher 66 as shown in FIG. 7 includes two detacher portions 68 slideably attached to each other. Preferably the detacher portions 68 can be pulled apart to any predetermined length. Preferably there is a fixed detacher portion 70 and a slideable detacher portion 72 and the slideable detacher portion slides along guide 74. The guide 74 may have marking thereon to indicate where to stop for specific applications. In addition the guide 74 may also include magnets to deactivate sensor label should it be an AM label. The adjustable detacher 66 is a simple manufacture that can easily be added to existing detacher units where retailers have invested in another technique.

It will be appreciated by those skilled in the art that the two lock tag is an improvement over existing one lock system since to easily remove the tag both locks need to be released at the same time. Accordingly although the asymmetric lock described above is the preferred lock to be used herein even where conventional ball locks are used there are advantages to the two lock tags. A conventional ball lock is shown generally at 76 in FIG. 8. Detacher 63 would also work for a two lock security tag with two conventional ball locks 76 and an AM sensor but the magnets 64 should be positioned directly below the locks 76. In detacher 78 three magnets 64 are set in a row with the centre magnet positioned for deactivating the sensor. With the conventional ball lock 76 different configurations of the locks for a predetermined span cannot be achieved.

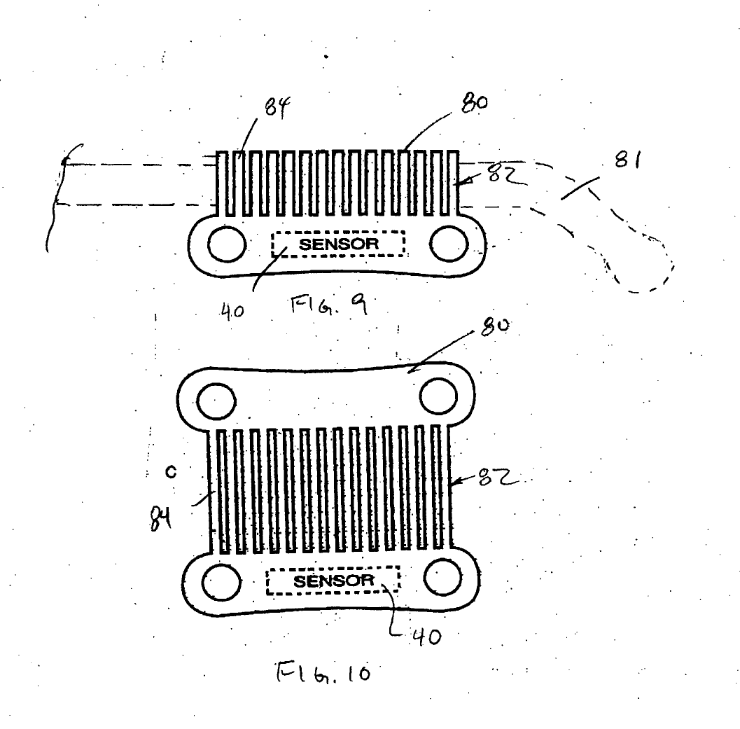

The two lock tag of the present invention also has a number of different variations that are specifically useful for merchandise other than clothing. For example the security device 80 shown in FIG. 9 and 10 is adapted for use with sun glasses, spectacles lenses and the like 81. Security device 80 includes a flexible bridging member 82 which is made up of a plurality of individual flexible bridging portions 84. Each bridging portion 84 is attached between the male portion 32 and a female portion 34. Since there are a plurality of bridging portions 84 the security device 80 can more easily fit over the arm of the spectacles 81 and be attached thereto. Preferably the tag 80 includes a sensor 40. Preferably the locks are asymmetric locks which generally weigh less than the conventional ball locks. It is advantageous to use the asymmetric lock because the security device thereby provides a more light weight security device. Thus the customer can more easily try on the spectacles with the security device attached thereto. Sensor 40 may be of the type that is deactivated while the security device 80 remains with the product when the customer leaves the store. The customer could then cut the device off the product at home.

Preferably the length of the security device 80 is at least half the length of the arm of the spectacles. Many spectacles have arms which are curved at the end thus making it more difficult to slide the security device around the arm. This is particularly true the longer security device 80. Other advantages of this design are that when the spectacles are displayed the security device is not in the front of the spectacles or on the bridge. Preferably felt material is attached to the inside of the security device to reduce the risk of the arm being scratched.

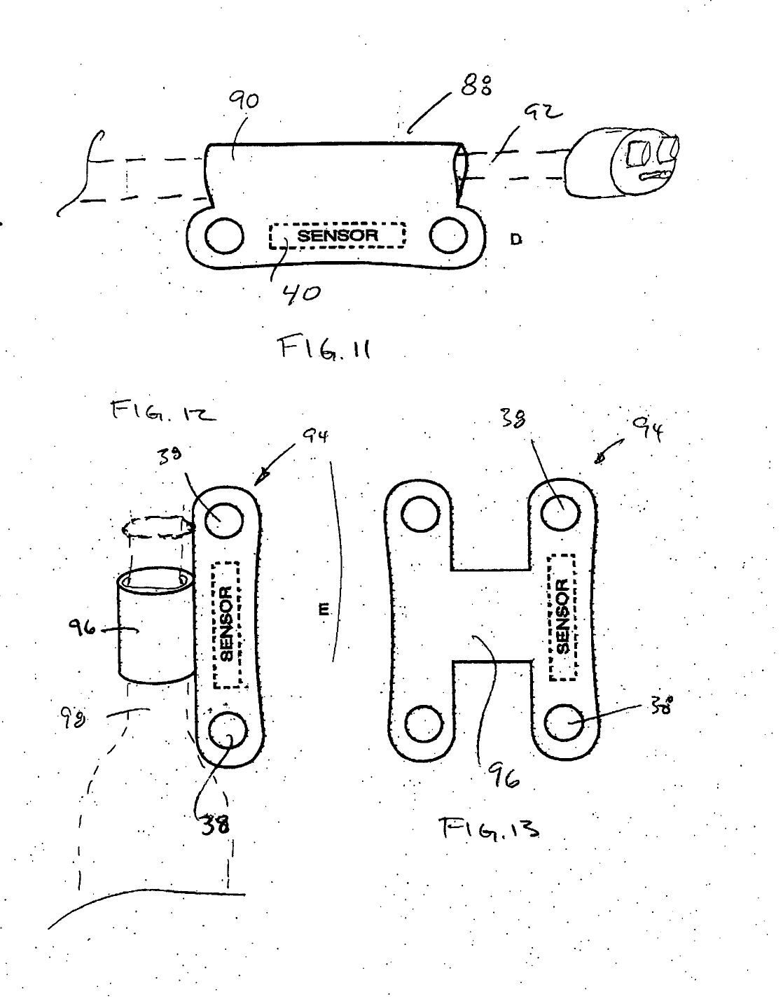

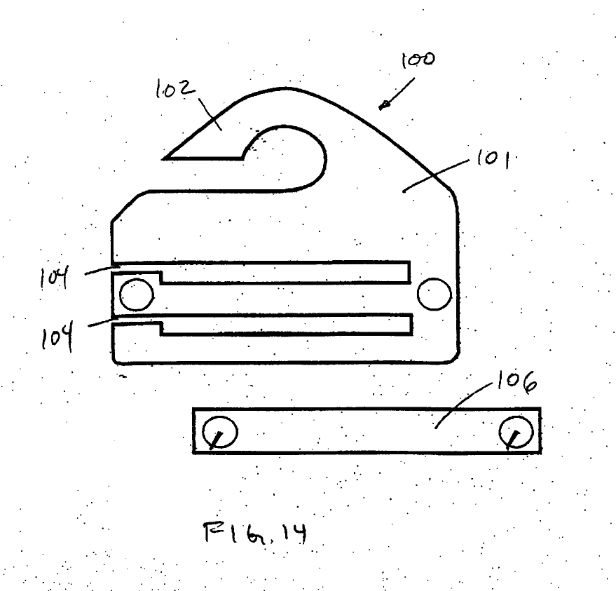

Referring to FIG. 11, the security device 88 Is similar to that shown in FIGS. 9 and 10 but with a solid flexible bridging portion 90. This embodiment 88 of the security tag of the present invention is particularly useful for hardware goods such as power drills, DVD players, toaster and the like. This security device 88 can be placed around the power cord 92 of the particular device. As discussed above the security device 88 may be disposable and the sensor 40 would be deactivated on payment for the product and the device would remain with the product after the sale. Alternatively device 88 can be released and reused. A similar security device 94 is shown in FIGS. 12 and 13. As with all of the embodiments having a bridging member described herein the bridging member may be dimensioned for a particular purpose. For example it can be dimensioned to fit a wine bottle, fishing rod, golf club and the like. The bridging member 96 of security device 94 is narrower than the span between the locks 38. In the example herein it is shown over a wine bottle 98. The security devices 80, 88 and 94 that include bridging members are attached to the product by wrapping the bridging member around some part of the product and then attaching the pins 36 to the locks 38.

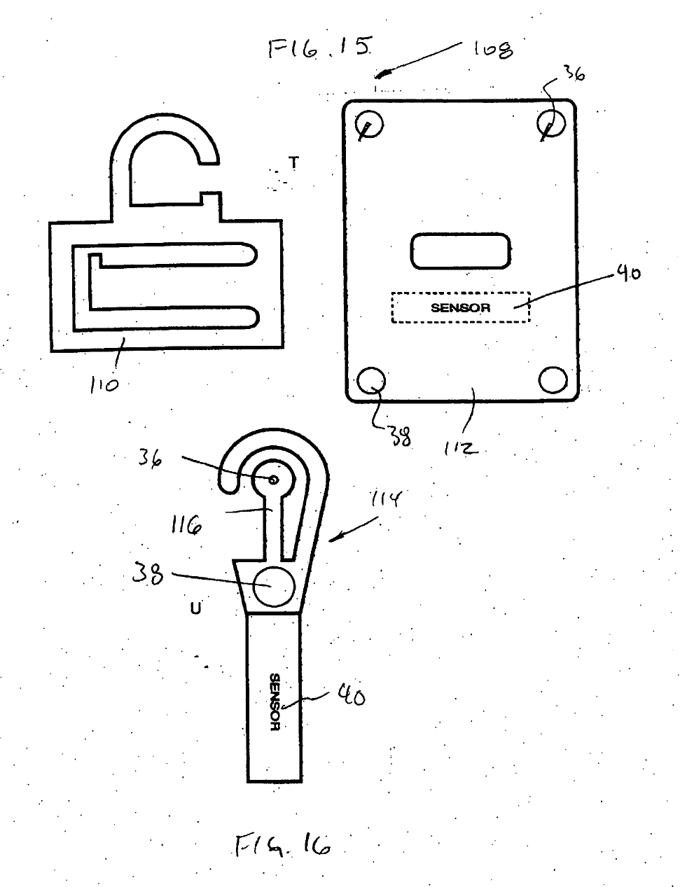

The security device of the present invention may have other modifications to accommodate other types of merchandise. For example a hanger type device may be modified to include a security device as shown in FIG. 14 at 100. The hanger type device includes a hanger female portion 101 with a hook 102 and two slots 104 to receive a tie, a belt, a scarf or the like. The hanger female portion 101 connects with a male portion 106. As discussed above, the sensor (not shown) can be placed with the hanger female portion 101 or the male portion 106. The retailer may merely deactivate the senor and leave the security device with the product or the retailer may remove the security device and reuse it. The design of the hanger type device is typical of just one style. However, it will be appreciated by those skilled in the art that there are a variety of different hanger type devices and all of them may be adapted to be used with the security device of the present invention. An alternate hanger type device is shown at 108 in FIG. 15. As with the previous device it can be used for ties, belts, scarves and the like. Device 108 includes a hanger portion 110 and a lock portion 112. The hanger portion 110 is a typical type hanger portion. The lock portion 112 is a bendable plastic with two pins 36 and two locks 38 with the sensor adhered thereto. The lock portion 112 bends around the tie hanger and locks. An advantage of this embodiment is that it may be used such that no pins pierce the tie material.

A convention hanger may be adapted in accordance with the present invention so that it is a security device. Specifically hanger 114 shown in FIG. 16 includes an elongate tab portion 116 with a pin 36 that engages a lock 38 once the item (not shown) is positioned therein. The pin 36 is secured through at least a portion of the small product. A sensor 40 is attached to the hanger 114. As discussed above the sensor would be deactivated at the point of sale. These type of hangers are typically used in conjunction with socks, ties or other items.

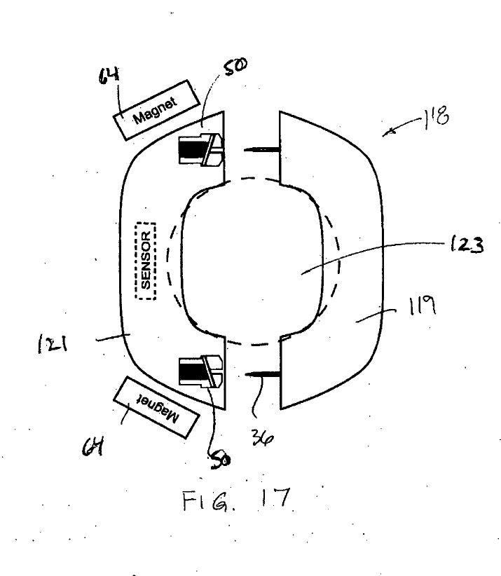

Referring to FIG. 17, an alternate embodiment of the security device 118 of the present invention is adapted for use with products having a generally round portion such as wine bottles, baseball bats and the like. Security device 118 includes a male portions 119 having two pins 36 extending outwardly therefrom and a female portion 121 having two locks therein. Preferably the locks are asymmetric locks. The security device 118 may include a sensor 40. Preferably the security device 1 18 is made from molded plastic and the generally circular opening 123 in the middle thereof is sized to fit the particular product. As discussed above the security device may be removed at the point of sale or the sensor may be deactivated and the device is disposed of by the purchaser. FIG. 17 also shows the preferred position of the magnets 64 oriented to release the pins secured in locks 50 as oriented in this particular configuration.

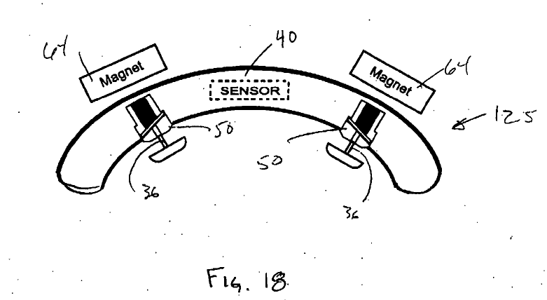

Referring to FIG. 18, another alternate embodiment of the security device of the present invention is shown at 125. Security device 125 includes a generally curved female portion 127 having two locks therein. Preferably the locks are asymmetric locks 50. Optionally the security device 125 may include a sensor. The advantage of this embodiment of the security device 125 is that if a thief tries to defeat the security device by attempting to cut off the pins 36 it would be very difficult to get at the pins 36. The preferred orientation of the magnets 64 are also shown in FIG. 18.

Referring to FIG. 19, the security device 130 of the presenting invention is adapted for use in association with CD, DVD, software, video tapes and the like. A jewel case or other type of container includes pins 36 and locks 38. Accordingly the locks hold the pins in place so that someone cannot access the booklet 132 inside without releasing the locks 38. Preferably the pins 36 used in association with the jewel case are shallow and blunt and therefore not uncomfortable to touch. The security device 130 is ideal in rental environments of retailing or libraries where items are circulated. Alternatively, in retail establishments the pins could be removed at the point of sale. As discussed above in regard to FIG. 2, an alternate solution for this type of merchandise is to use a male portion that clamps the exterior and when released stay within the store and the jewel case with the locks attached thereto goes with the customer. The position of the locks 38 can vary to disguise positioning of locks from the outside of case so that illicit removal is made more difficult.

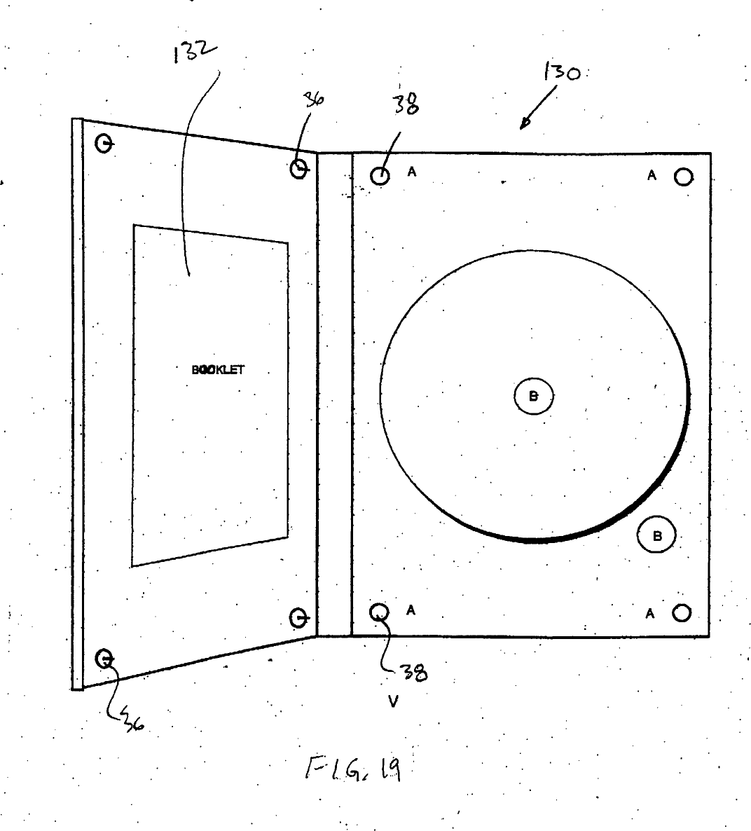

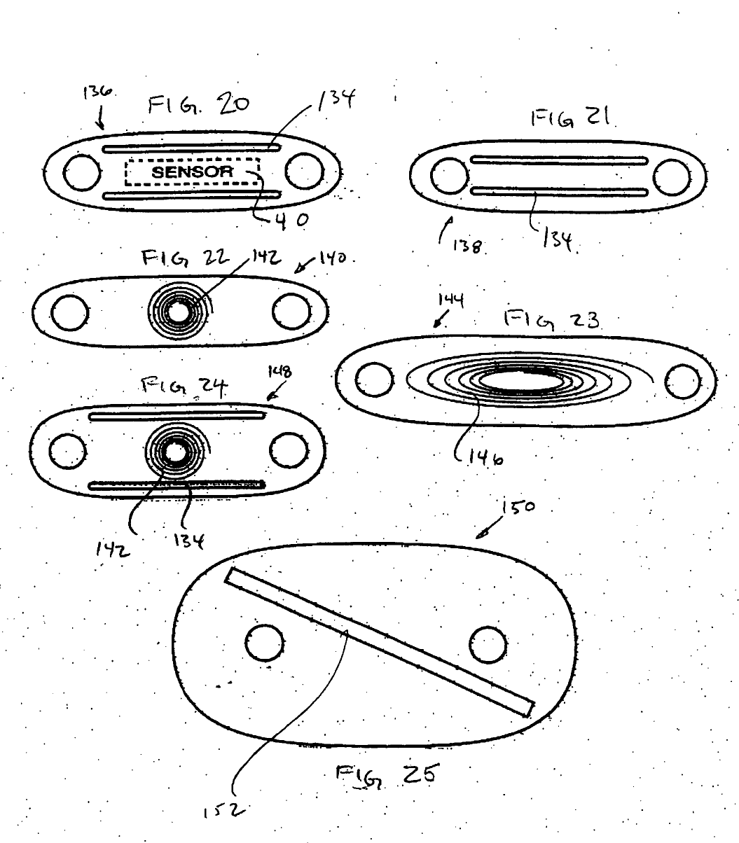

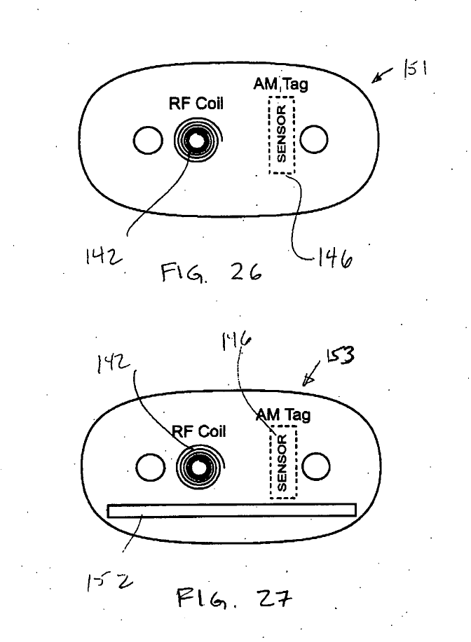

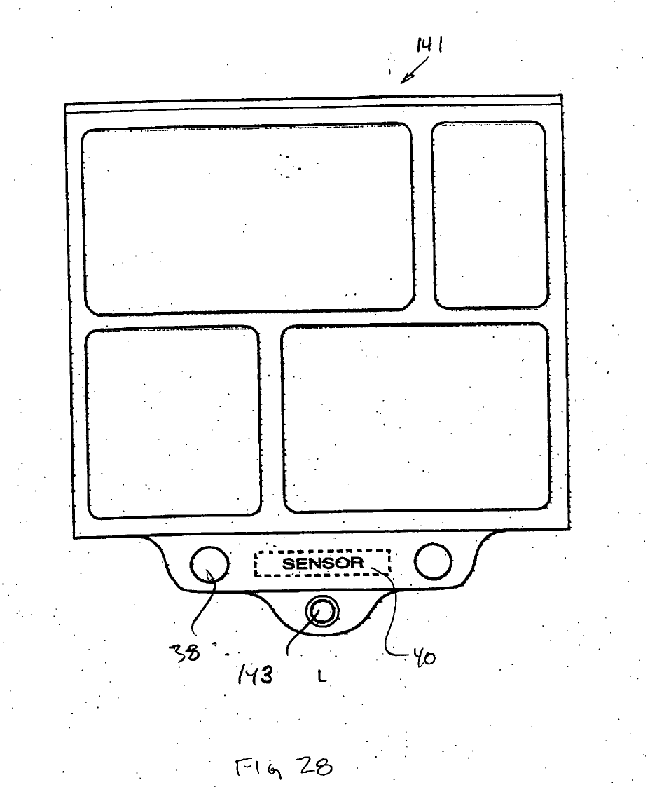

It will be appreciated by those skilled in the art that the security devices of the present invention may have no sensor or a variety of different sensors attached thereto. Example of this are shown in FIGS. 20 to 227. The security device of the present invention may have ink vials 134 attached thereto for added protection and deterrence as shown at 136 in FIG. 20. Security device 138 shown in FIG. 21 has ink vials 134 only and no sensor. In FIG. 22 the security tag 140 has an RF coil 142 while in FIG. 23 the security tag 144 has an AM sensor 146. Note that generally an AM sensor is not used because of its relative cost. Security device 148 shown in FIG. 24 includes a RF sensor 142 and ink vials 134. The security device 150 shown in FIG. 25 includes an electromagnetic label 152 positioned at an angle. The security device 151 shown in FIG. 26 includes a RF sensor 142 and an AM sensor 146. The security device 153 shown in FIG. 27 includes an RF sensor 142, an AM sensor 146 and an electro-magnetic label 152. Alternatively two electromagnetic strips in a cross section could also be added. This is ideal for retailers or libraries using electro-magnetic technology.

With the introduction of RFID (radio frequency identification), a RFID antenna could also be used as identification for protection of brands. The RFID sensor could provide information about the very same garment eg: Type of Cotton, Design No, Colour, size, date of manufacture, barcode number, sale price, discount prices etc. RFID Technology can be added to all security items for identification and inventory control.

It will be appreciated by those skilled in the art that a wide variety of sensors may be used in conjunction with the security system of the present invention. The type and frequency of sensor will be chosen by the user to be compatible with their system. For example, the sensor may be an AM label such as an Accousto Magnetic label produced by Tyco (sensormatic). This label sensor can also be deactivated at the point of sale by a magnet. Magnets can be positioned below the sensor should the need arise to deactivate the label at same time of releasing the lock mechanism. Some retailers may not require this option. The AM sensor could be deactivatible or permanent i.e. cannot be desensitized and always remains a passive tag.

An alternative sensor could also include other popular frequencies such as Electro-magnetic and Radio Frequency.

Another common way of displaying merchandise is with the use of a blister package. Heretofore, blister packages have not been used in conjunction with security devices. An example of a blister package in conjunction with a security device is shown at 141 in FIG. 28. Blister packages are used with a wide variety of products. In hardware stores for examples blister packages are used with plumbing parts, assortment of parts, screws, washers and the like. As well blister packages are used to protect ink cartridges, saw blades, and socks to name just a few further examples.

The lock 38 may form part of the blister package and therefore could be part of all packaging in a retail environment. As discussed above if desired a sensor 40 may be included which would be deactivated at the point of sale. Alternatively the retailed could drop a sensor inside a finished packaging. The third hole 143 is for hanging the item for display.

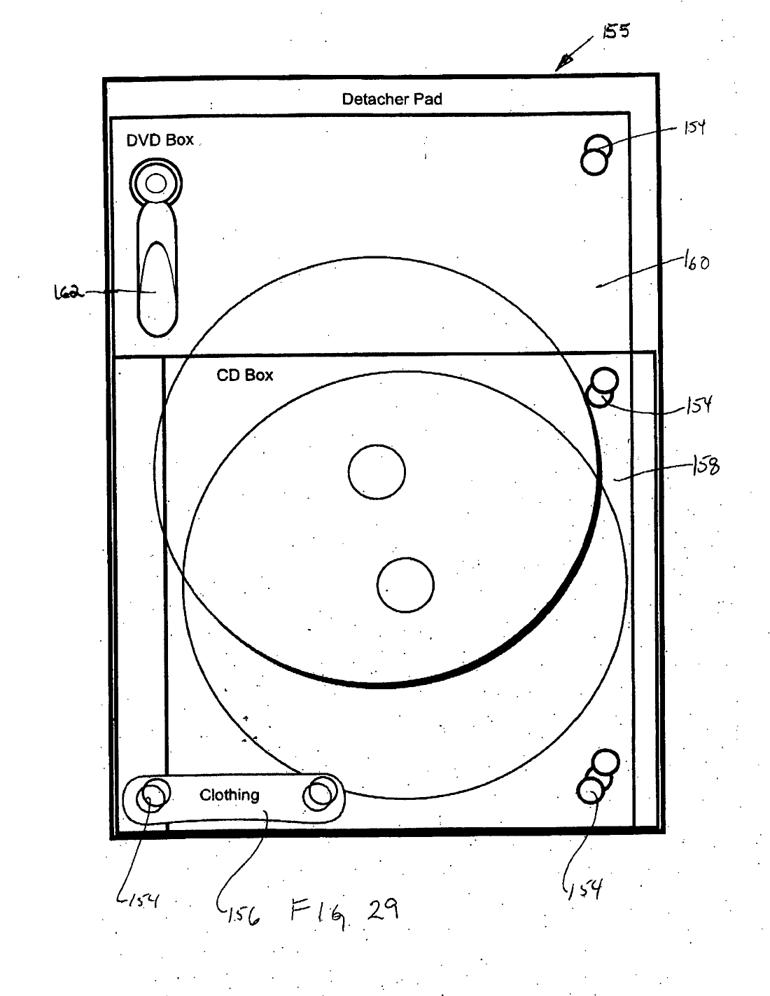

Referring to FIG. 29 a detacher is shown at 155. Detacher 155 has plurality of detacher portions 154 arranged to correspond with a plurality of different security devices. For example the detacher portions are arranged to release a security device 156 generally used with clothing, a security device 158 generally used with CD's and a security device 160 generally used with DVD's. As well it could include a detacher portion for use in association with a single lock security device 162. However, it will be appreciated by those skilled in the art that further detacher portions may be added to remove other security devices for specific applications. The pad could have images or outlines of items such as sunglasses, jeans, ties, CD etc or letters or lines showing where to place security items. As discussed previously the configuration of the locks can be unique for a retailer and thus the detacher 150 would also be unique for a specific retailer. As well, the security devices may include dummy locks to further confuse potential thieves. In addition, the configuration and/or orientation of the locks may be easily changed thus allowing the retailer to make it more difficult to consistently remove the security devices without the proper detacher. Additional magnets may be positioned to also deactivate the AM sensor known as the Chiclets made by Tyco (sensormatic). As well an RF Coil deactivation device for deactivation of RF labels may also be included within the pad 150.

In addition to the detacher 150 a deactivator 157 which is a magnetic pad is shown in FIG. 27. Deactivator 152 could easily encase an RF deactivation antennae, which is simply a wire loop around the edge of the casing. This unit could deactivate all technologies: AM, RF, or Electromagnetic the configuration of magnets provides deactivation lock mechanism release.

It will be appreciated by those skilled in the art that the embodiments shown herein for the security device of the present invention and the detachers provide many new ways to secure a wide variety of products. In the embodiment 80 shown in FIGS. 9 and 10, when the customer tries on the sunglasses the security device is less cumbersome than currently available security devices. In regard to security device 30 particularly useful for clothing in the embodiment wherein asymmetric locks are used the shorter pins may also be used and thus the overall depth of the device may be reduced. Often tags are in the way when a customer attempts to try on a piece of clothing, thus the embodiment wherein the asymmetric locks are used offers a slimmer bulge with use of a short pin. The use of the double locks in the security devices of the present invention provides extra security.

The advantage to the user is that this locking mechanism and method of detacher can be custom made for whole range of products and detached as well as touch deactivated if required at the point of sale (POS) by a variable style of detachers. A further feature is that the distance between the locks can be varied and the security device may be detached with an adjustable detacher 66 as shown see FIG. 6. With the adjustable detacher items of merchandise in varying blister packaged items or products such as ink cartridges maybe be packaged in different widths, the adjustable detacher can accommodate the variations of the security device shown in FIGS. 1, 2 and 9 through 17. All of these items could have different spaces between the locks and the security device may be chosen to be keeping with the style of merchandising in the rest of the store.

It is important to note that standard and more powerful magnets known in the market when placed below the washer spring of the asymmetric lock will not consistently release the pin from the mechanism. Preferably the magnet is positioned in an orientation that corresponds to the orientation of the wedge 56.

As well as both fixed detachers 62, 63 (shown in FIGS. 5 and 6) for use in association with one style of security device and an adjustable detacher 66 (shown in FIG. 6) there is also the detacher pad shown in FIG. 29 wherein magnets are hidden within the pad in any place where required to remove the security devices used in that particular retail establishment. In addition, it is feasible to offer a retailer his or her own signature deactivation pad wherein the specific orientation of the asymmetric locks and the distance between the locks is specific to that retailer. For example the double lock security device 30 ideal for clothing shown in FIG. 1, could vary in width, therefore magnetic detacher could vary as well as variation of locks left, left or right, right, so that retail neighbours could appear to have same family of security devices but different combination of magnetic detacher.

It will be appreciated by those skilled in the art that there are a number of advantages of the present security system. In particular it allows a retailer to use security devices with a wide range of products while using a single detacher. Further it allows a retailer to have a two lock security device with the orientation of asymmetric locks which are unique to a particular retailer. In addition the security device of the present invention could be made from plastic with the intention that they would not be removed from the clothes. Rather the retailer would deactivate the sensor at the point of sale. The security device of the present invention which uses the asymmetric lock is particularly suited for this application since it could have a very thin profile. An example of a thin profile plastic security device 164 is shown in FIGS. 31 to 33. Security device 164 has a single lock portion 166. It will be appreciated by those skilled in the art that all of the embodiments of the double lock security device described above could be made of all plastic and therefore designed to be sold with the product.

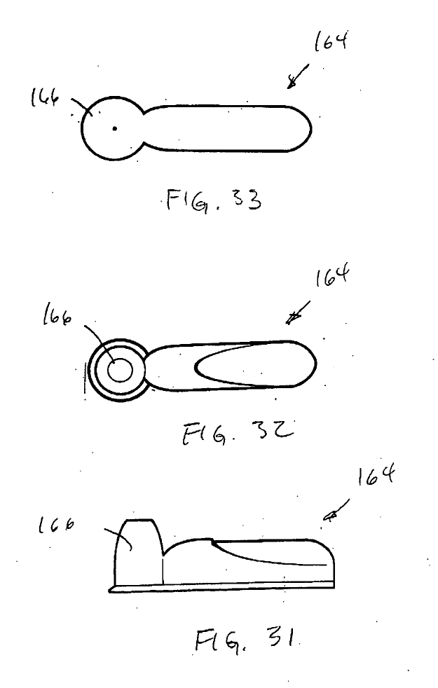

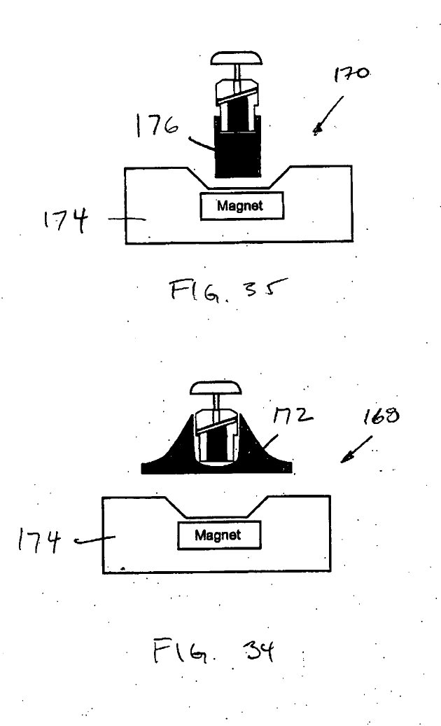

As discussed above, the asymmetric lock has a number advantages over the prior art ball type locks. One advantage is that the prior art detachers will not reliably release a pin from an asymmetric lock. The likelihood of the pin being removed from the asymmetric lock can further be decreased by changing the shape of the asymmetric lock so that it will not fit into a prior art detacher. Two examples of such locks are shown in FIGS. 33 and 34 at 168 and 170 respectively. In FIG. 33 the shape of asymmetric lock 50 is altered by adding a hill shaped seat 172. Thus lock 168 cannot fit into the prior art detacher 174 and therefore the pull of the magnet on the washer 54 will be quite weak thus reducing the likelihood of the magnet releasing the pine 36. Alternatively lock 170 has an elongate seat portion 176 and thus if used in a conventional detacher 174 the pull of the magnet will similarly be quite weak.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A security device comprising:
at least two pins;
at least two asymmetric locks each adapted to releasably receive one pin; and
wherein at least one of the at least two pins and one of the at least two lock are attached together and wherein the device has a release position wherein the pins are not in the locks and a locked position where the pins are secured in the locks.

2. A security device as claimed in claim 1 wherein the at least two pins are attached together to form a male portion and the at least two locks are attached together to form a female portion.

3. A security device as claimed in claim 2 wherein each asymmetric lock includes a spring, a washer having a pierced hole therein and an asymmetric wedge having a hole therein and wherein in the locked position the washer engages a pin inserted in the hole in the washer and through the asymmetric wedge.

4. A security device as claimed in claim 3 wherein there are two asymmetric locks and the asymmetric locks are arranged in such that the wedges are aligned in one of the following configuration both to the right side of the security device; both to the left side of the security device; both inwardly in the security device; and both facing outwardly in the security device.

5. A security device as claimed in claim 3 wherein the configuration of the asymmetric locks is unique to a predetermined retailer.

6. A security device as claimed in claim 2 wherein the male portion of the device and the female portion of the device are connected with a flexible bridging member.

7. A security device as claimed in claim 6 wherein the flexible bridging member is adapted to be secured over one of sunglasses, a power chord and a golf club.

8. A security device as claimed in claim 6 wherein the flexible bridging member is a plurality of flexible bridging members each connected between the male portion and the female portion.

9. A security device as claimed in claim 2 wherein the male portion is generally arc shaped and the female portion is generally arc shaped and the wherein in the locked position the locked position there is a hole formed between the male portion and female portion.

10. A security device as claimed in claim 2 wherein at least one of the male portion and the female portion is generally arc shaped.

11. A security device as claimed in claim 2 wherein one of the male portion and the female includes a plurality of slots adapted to receive a product.

12. A security device as claimed in claim 2 further including a hanger portion adapted to receive a product.

13. A security device as claimed in claim 1 wherein the pins and the locks are connected to a jewel case for use in association with one of a CD and DVD.

14. A security device as claimed in claim 13 wherein the arrangement of pins and locks is unique to a predetermined retailer.

15. A security device as claimed in claim 13 including a plurality of locks and a corresponding plurality of pins.

16. A security device as claimed in claim 1 wherein the security device further includes at least one a sensor.

17. A security device as claimed in claim 16 wherein the sensor is chosen from the group consisting of an RF sensor, an AM sensor, an electromagnetic sensor and a combination thereof.

18. A security device as claimed in claim 17 wherein the security device further includes an ink vial.

19. A security device as claimed in claim 1 wherein the security device further includes an ink vial.

20. A security device as claimed in claim 1 wherein the security device is manufactured from non-metallic material.

21. A detacher assembly for use in association with security devices having at least two locks and a corresponding number of pins comprising:
a plurality of detachers corresponding to the number of locks associated with the security device.

22. A detacher assembly as claimed in claim 21 wherein each detacher includes a magnet arranged to release the corresponding lock in an asymmetric lock.

23. A detacher assembly as claimed in claim 21 wherein the detacher assembly includes two detachers slideably attached together.

24. A detacher assembly as claimed in claim 23 wherein the detacher further includes a magnet for deactivating a sensor.

25. A detacher assembly as claimed in claim 21 wherein the detacher assembly includes a plurality of detachers adapted to correspond to the locks positioned in a plurality of different security devices.

26. A detacher assembly as claimed in claim 25 wherein the detacher assembly further includes outlines that correspond to the plurality of different security devices.

27. A detacher assembly as claimed in claim 26 wherein the plurality of different security devices include a two lock security device, a DVD security device and a CD security device.

28. A detacher assembly as claimed in claim 27 wherein the plurality of different security devices include a one lock security device.

29. A detacher as claimed in claim 25 further includes a plurality of magnets positioned to deactivate a plurality of sensors associated with the plurality of different security devices.

30. A detacher assembly as claimed in claim 21 wherein the spacing of the detachers corresponds to the spacing of locks on a jewel case adapted for use with a digital storage device.

31. A security device adapted to be attached to a product comprising:
at least two spaced apart pins attached together to form a male portion;
at least two spaced apart locks attached together to form a female portion each lock adapted to releasably receive one pin; and
a bridging member connecting the male portion and the female portion, wherein the device has a release position wherein the pins are not in the locks and a locked position where the pins are secured in the locks and wherein in the locked position the bridging member is wrapped around a portion of the product.

32. A security device as claimed in claim 31 wherein the flexible bridging member is adapted to be secured over one of sunglasses, a power chord and a golf club.

33. A security device as claimed in claim 31 wherein the flexible bridging member is a plurality of flexible bridging members each connected between the male portion and the female portion.

34. A security device as claimed in claim 31 wherein the locks are ball type locks.

35. A security device as claimed in claim 33 wherein the locks are ball type locks.

36. A security device adapted to be attached to a product comprising:
at least one pin on a male portion;
at least one lock on a female portion, each lock adapted to releasably receive one pin; and
wherein the security device is manufactured from non-metallic material.

37. A security device for use in association with digital storage medium such as CD's, DVD's and the like comprising:
a jewel case adapted to receive the digital storage medium having a front portion and a back portion;
at least two locks connected to the jewel case; and
at least two pins each releasably connectable to the one of the locks.

38. A security device as claimed in claim 37 wherein there are two pins connected to form a male portion and one of the two pins is adapted to be received in a lock that is below a hole in the middle of the storage medium and the other of the two pins is adapted to be positioned outside the periphery of the storage medium.

39. A security device as claimed in claim 37 wherein there are a plurality of locks and a corresponding plurality of pins and the plurality of locks are formed in one of the front portion and the back portion and the plurality of pins are formed in the other of the front portion and the back portion.

40. A security device as claimed in claim 37 wherein the locks are ball type locks.

41. A security device as claimed in claim 37 wherein the arrangement of pins and locks is unique to a predetermined retailer.

42. A security device comprising:
a blister package having at least one lock; and
at least one pin adapted to be releasably connected to the lock.

43. A security device as claimed in claim 42 further including a sensor.

44. A security device as claimed in claim 43 wherein the lock is a ball type lock.

45. A security device as claimed in claim 43 wherein the lock is an asymmetric lock.

46. A security device for use in association with small products such as ties, socks, belts and the like comprising;
a hanger portion;
a lock connected to the hanger portion;
a pin connected to the hanger portion; and
wherein there is a release position wherein the pin is not in the lock and a locked position wherein the pin is secured in the lock through at least a portion of the small product.

47. A security device as claimed in claim 46 further including a sensor.

48. A security device as claimed in claim 47 wherein the lock is an asymmetric lock.

49. A security device as claimed in claim 47 wherein the lock is a ball type lock.
